(19) United States
(12) Patent Application Publication
(10) Pub. No.: US 2018/0229392 A1
(43) Pub. Date: Aug. 16, 2018

(54) PUNCH JAWS AND PUNCH DEVICE COMPRISING A PUNCH SLEEVE AND A PUNCH OPENING

(71) Applicant: Gustav Klauke GmbH, Remschied (DE)

(72) Inventors: Egbert Frenken, Heinsberg (DE); Gerald Tully, Hampshire, IL (US)

(21) Appl. No.: 15/750,061

(22) PCT Filed: Aug. 1, 2016
(86) PCT No.: PCT/EP2016/068320

§ 371 Date: Feb. 2, 2018

(30) Foreign Application Priority Data
Aug. 3, 2015 (DE) 10 2015 112 724.5

(51) Int. Cl. B26F 1/36; B21D 28/24; B21D 28/26; B21D 28/34; B26F 1/14; B21D 28/00

(52) U.S. Cl. CPC B26F 1/36; B21D 28/243; B21D 28/26; B26F 2001/365; B26F 1/14; B21D 28/002; B21D 28/34

(57) ABSTRACT

Punch jaws are provided and are configured to punch holes and/or recesses in parts made of sheet metal. The punch jaws include first and second jaws pivotally connected to each other around a pivoting axis to pivot in a pivoting plane. A work region is formed by a punch ram on the first pivoting jaw and a punch opening on the second pivoting jaw. The punch ram carries a punch sleeve having a punch edge on its circumference. The punch sleeve moves in a side view, in which the pivoting axis is punctiform, along a circular line, a center point of which is formed by the pivoting axis, during its pivoting motion. The punch sleeve is introduced into the punch opening in a side view initially penetrates the punch opening with a front region the punch edge referred to the pivoting direction. The front region is in this side view formed on the side of the pivoting axis of the circular line with respect to a pivoting circle, along which the punch sleeve moves.

### TECHNICAL FIELD

The invention initially pertains to punch jaws realized in the form of pivoting jaws, which can be connected to a preferably electrohydraulically actuatable handheld device and are connected in order to pivot in a pivoting plane, for punching holes and/or recesses in parts that are preferably made of sheet metal, wherein a work region is formed by a punch ram on a first pivoting jaw and a punch opening on the second pivoting jaw, wherein the punch ram carries a punch sleeve and the punch sleeve features a punch edge on its circumference, and wherein the punch sleeve moves in a side view, in which the pivoting axis is punctiform, along a circular line, the center point of which is formed by the pivoting axis, during its pivoting motion.

The invention also pertains to a punch device with a punch sleeve and a punch opening, wherein the punch sleeve can be displaced relative to the punch opening in a motor-driven fashion, preferably electrohydraulically, and features a punch edge in order to punch materials to be punched.

The invention furthermore pertains to a punch device with a punch sleeve and a punch opening, wherein the punch sleeve can be displaced relative to the punch opening in a motor-driven fashion, preferably electrohydraulically, and features a punch edge in order to punch materials to be punched, and wherein the punch sleeve is mounted on a punch ram in an exchangeable fashion.

### PRIOR ART

Punch jaws, pivoting jaws and punch devices of the type described herein, namely also punch devices, in which the punch ram is mounted in an exchangeable fashion, are already known from WO 2013/017535 A2.

### SUMMARY OF THE INVENTION

Based on the known prior art, the invention is based on the objective of advantageously enhancing punch jaws realized in the form of pivoting jaws. The invention also aims to disclose a conveniently usable punch device with the punch sleeve and a punch opening. The invention furthermore aims to disclose a punch device with a conveniently usable mounting for a punch sleeve on a punch ram.

According to a first inventive idea, the objective of the invention is potentially attained with punch jaws realized in the form of pivoting jaws, in which the punch sleeve being introduced into the punch opening in a side view initially penetrates the punch opening with a front region of its punch edge referred to the pivoting direction, and in which the front region is in this side view formed on the side of the pivoting axis of the circular line with respect to a pivoting circle, along which the punch sleeve moves.

Accordingly, the punch sleeve initially penetrates the material to be punched, for example a sheet metal part, with the front region. The punch ram can be altogether centered relative to the punch opening due to the initially penetrating front region of the punch sleeve. An alignment of the punch opening relative to the punch ram and the punch sleeve can thereby also be achieved. In this way, the punch pattern in the material to be punched, for example in a sheet metal part, is improved.

The front region may respectively impinge upon the material to be punched and penetrate into the punch opening in a punctiform fashion during the course of the pivoting motion of the pivoting jaw. In this respect, it would also be possible, for example, to provide two front regions that are spaced apart from one another and respectively penetrate into the punch opening and impinge upon the sheet metal part simultaneously as they move along two pivoting circles, which are arranged congruently in the direction of the pivoting axis.

With respect to a top view of the punch sleeve, in which the pivoting axis represents a line, the punch sleeve may have an annular punch edge or alternatively a noncircular punch edge, for example a square or elongate rectangular, hexagonal or oval punch edge.

According to another inventive idea, the objective with respect to the punch device with a punch sleeve and a punch opening is potentially attained in that a holding element extends through the punch opening with an offset relative to an outer edge of the punch opening in the punching direction.

The holding element preferably traverses the punch opening in a plane, which in the punching position is offset relative to a punch edge of the punch sleeve in the punching direction. The holding element influences the section punched out of the material to be punched and can furthermore prevent the punched-out section from uncontrollably falling out.

According to another inventive idea, this objective is potentially attained with a punch device, in which the punch edge features a stop that in a cross section is set back in the displacement direction and arranged outward referred to the punch edge, wherein said stop can come in contact with the material to be punched during the course of a punching operation.

In this way, the penetration depth of the punch sleeve is limited in a defined fashion, if applicable in dependence on the thickness of the material to be punched. The stop can preferably be formed on the punch sleeve.

According to another inventive idea, the objective with respect to a punch device with a punch sleeve, which is mounted on the punch ram in an exchangeable fashion, is potentially attained in that a locking element can be displaced into a release position against a spring force and/or moved into a release position by means of a slotted link guide.

The punch sleeve preferably can be respectively mounted on and dismounted from the punch ram without tools. For example, the punch sleeve can be dismounted from the punch ram by displacing a locking element into a release position against a spring force, particularly as a result of a corresponding manual actuation by the user. Due to the spring acting upon the locking element, the mounting position can be automatically assumed in a predefined orientation of the punch sleeve relative to the punch ram.

In this context, it would furthermore be possible to provide a slotted link guide, by means of which the user can carry out, for example, a rotational and linear motion of the punch sleeve relative to the punch ram in order to respectively release the punch sleeve from the punch ram and to correspondingly mount the punch sleeve on the punch ram.

According to the proposed solution, the punch sleeve can be conveniently exchanged quickly and without tools, preferably as a result of a one-handed manipulation of the punch sleeve.

The characteristics of the above-described independent claims respectively are significant individually, as well as in any combination with one another, wherein characteristics of an independent claim can also be combined with the characteristics of another independent claim or with characteristics of multiple independent claims, as well as with only individual characteristics of one or more of the other independent claims.

Other characteristics of the invention are described below, as well as in the description of the figures, frequently in their preferred association with the object of claim 1 and/or one more of independent claims 2-4 or with characteristics of other claims. However, they may also be respectively significant in association with only individual characteristics of claim 1 and/or one or more of independent claims 2-4 or the respective other claim or independently.

According to a preferred embodiment, the front region of the punch edge is in a top view of the punch sleeve, in which the pivoting axis represents a line, realized symmetrically referred to a diametric line of the punch sleeve extending perpendicular to the pivoting axis. If the front region is designed in the form of a point of the punch edge, it is referred to the top view preferably arranged on the diametric line. If two front regions in the form of punch edge points are provided, for example in a square outline of the punch edge, they are preferably arranged symmetrical to the diametric line and accordingly to both sides thereof.

It is also preferred that the front region includes the section of the punch edge, which in the aforementioned side view extends closest to the pivoting axis. The front region may be a region that, although associated with the punch edge, is realized separately thereof. In a potential embodiment, the front region directly forms part of the punch edge.

The cant of the front region in the pivoting direction may be formed in the section of the punch edge located closest to the pivoting axis. In this context, the cant should be interpreted as an extension in the pivoting direction of the punch sleeve relative to a radius line, wherein said radius line extends through the region (point) of the punch edge, which in the side view protrudes farthest rearward referred to the pivoting direction.

The holding element, which is preferably provided in the region of the punch opening, may have a base area that corresponds to the punch opening. In a preferred embodiment, the holding element is a holding rod, the area of which is, when projected into the punch opening area, smaller than the punch opening area and, for example, corresponds to 0.1-times to 0.5-times the punch opening area.

The holding rod may also extend on a diametric line if the outer edge is realized annular. Two or more rod-shaped holding elements may furthermore be provided. If applicable, the arrangement of only one holding element, particularly in the form of a holding rod, provides convenient access for respectively removing or separating the punched-out section.

The holding rod may also extend perpendicular to at least one side of the outer edge and/or through a center point of the area encompassed by the outer edge if the outer edge is realized rectangular or square. The area encompassed by the outer edge is preferably divided into partial areas of the same size due to the arrangement of the holding rod.

Furthermore, the holding rod may transverse to its longitudinal direction have a cross section in the shape of a circular disk or alternatively a noncircular cross section, if applicable a polygonal cross section.

With respect to the stop on the punch sleeve, the stop is in a preferred embodiment realized in the form of a circumferential shoulder. In this context, the stop may extend over the entire circumference of the punch sleeve. In another potential embodiment, the stop or the shoulder forming the stop is interrupted over the circumference.

Furthermore, the stop may in a cross-sectional contour extend in a curved fashion in the stopping direction, preferably with a concave curvature from the radially outer side toward the radially inner side. In this case, the limit stop may be defined by the contact of the punch sleeve with the punched outer edge of the material to be punched in the region of the curved contour of the stop on sleeve.

With respect to the exchangeable mounting of the punch sleeve on the punch ram, the locking element may in an enhancement be realized in the form of a locking pin that is spring-loaded radially inward and arranged in a radially movable fashion. The locking pin preferably is captively held on the punch sleeve. The radial mobility of the locking pin and the spring preload are used for locking the punch sleeve on the punch ram. A preferably manual displacement of the locking pin against the spring preload disengages the catch mounting of the punch sleeve on the punch ram. For this purpose, the locking pin may form a corresponding handle at a conveniently accessible location.

In a locking position, the locking pin preferably penetrates into an interlock opening of the punch ram. The cross section of the interlock opening is preferably adapted to the locking pin in the region of its interlock section.

The punch sleeve can preferably be surrounded by a stripper sleeve. In this case, the locking pin may extend through the stripper sleeve opposite of its interlock section.

In an arrangement with a stripper sleeve, the locking pin can preferably also be actuated from outside the stripper sleeve, particularly by being displaced relative to the punch sleeve in the radial direction. For this purpose, the locking pin may be provided with a handle outside the stripper sleeve, wherein said handle can be taken hold of by the user in order to act upon the locking pin by pushing radially inward and/or pulling radially outward.

The stripper sleeve may be connected to the punch sleeve by means of the locking pin only. However, a mounting pin may be arranged on the punch sleeve in addition to the locking pin and extend through the stripper sleeve with a circumferential offset referred to the locking pin, for example diametrically opposite thereof. The mounting pin is preferably fixed on the punch sleeve such that it cannot be displaced, particularly not displaced in the radial direction. In an alternative embodiment, multiple locking pins, for example two locking pins, may be provided with a circumferential offset to one another and simultaneously engage into the stripper sleeve.

In a preferred embodiment, the stripper sleeve can be displaced relative to the punch sleeve in the direction of the longitudinal punch ram axis. This may be achieved by accommodating the locking pin and/or the mounting pin in an oblong hole of the stripper sleeve. The oblong hole or the circumferentially offset oblong holes of the stripper sleeve extend in the direction of the longitudinal punch ram axis. Due to the engagement of the locking pin and/or the mounting pin into the oblong holes, the stripper sleeve is mounted on the punch sleeve and simultaneously can be displaced relative thereto in a sliding fashion. In this context, it is furthermore preferred that the locking element is captively held on the stripper sleeve.

The locking pin may also be acted upon in the direction of the locking position by means of a spring element arranged the punch ram. The spring element may consist of a separate spring element, for example, in the form of a pressure spring, particularly a metal pressure spring. The spring element may also consist of an elastically resilient material such as a thermoplastic elastomer or rubber.

The spring in the punch ram may be arranged such that it acts in the displacement direction of the locking pin, for example in the radial direction. Alternatively, the spring may also be arranged in the punch ram such that it acts transverse to the displacement direction of the locking pin, for example upon an interlock element that blocks the locking pin in the locking position.

In another embodiment, the locking pin may act upon a spacer, which is supported on the spring, by means of the spring. This spacer may be arranged in an axial extension of the locking pin. Furthermore, the spacer and preferably also the spring may form part of the punch ram. The end of the spacer associated with the locking pin can be displaced into a parting plane between the punch ram and the punch sleeve in order to assume a catch-mounting position.

It is preferred to provide two cross-sectionally opposite locking pins. It is furthermore preferred to also provide two cross-sectionally opposite spacers that in the locking position extend beyond the parting plane between the punch ram and the punch sleeve, namely as far as a bore in the punch sleeve that accommodates the locking pins. The locking pins can be simultaneously actuated with the fingers of one hand, particularly in order to disengage the catch connection between the punch ram and the punch sleeve as a result of a radially inward motion of the of the locking pins, by means of which the parting planes between the spacers and the locking pins are displaced into the parting plane between the punch sleeve and the punch ram.

The oppositely arranged spacers are preferably acted upon by the same spring. In this context, it is preferred to provide a pressure spring, particularly a helical pressure spring, the ends of which respectively act upon one spacer.

In another alternative embodiment, the locking pin may on the side of the punch ram be movable in a slotted link that is angularly formed on the punch ram. The slotted link serves for fixing the punch sleeve on the punch ram in cooperation with the associated free end of the locking pin. The slotted link is preferably formed in the outer wall of a region of the punch ram accommodating the punch sleeve, for example in the form of a groove.

The slotted link may feature a locking section extending transverse to the longitudinal axis of the punch ram and a removal section extending in the direction of the longitudinal axis. In this case, the removal section preferably ends openly in the region of a free end face of the punch ram. The punch sleeve can be attached to the punch ram in the direction of the longitudinal axis thereof with an optionally non-displaceable locking pin, particularly a radially non-displaceable locking pin, which is held in the punch sleeve and fixed on the punch ram due to a subsequent rotational displacement and therefore the engagement of the locking pin into the locking section extending in the locking direction.

The mounted position of the punch sleeve on the punch ram may furthermore be secured. For this purpose, a locking recess may be formed on the locking section on its end lying opposite of the removal section. The locking pin, which can be radially displaced with reference to the longitudinal axis of the punch ram, can engage into this locking recess in an interlocking fashion.

On the end of the locking section, the slotted link may also end in a widened locking section, into which the locking pin engages during the course of catching the punch sleeve on the punch ram. In this case, the locking pin may be realized in the form of a clamping sleeve that can be spring-loaded in the circumferential direction thereof and the diameter of which in the relaxed state corresponds to the diameter of the widened slotted link region. In contrast, the width of the removal section, as well as of the locking section leading to the widened region, transverse to the displacement direction is chosen smaller than the diameter of the clamping sleeve such that its diameter is reduced against the spring force, which is only released in the widened region of the slotted link, during the course of the attachment and locking motion of the punch sleeve.

The locking pin can only exit the locking recess or the widened slotted link region against the spring force, for example as a result of a corresponding displacement of the locking pin opposite to the spring force in order to overcome the locking recess or, if the locking pin is realized in the form of a clamping sleeve and a widened region is provided on the end of the slotted link, as a result of rotationally acting upon the punch sleeve, during the course of which the clamping sleeve is pushed into the narrowed slotted link section.

### BRIEF DESCRIPTION OF THE DRAWINGS

The invention is described below with reference to the attached drawings that, however, merely show exemplary embodiments. A component, which is only described with reference to one of the exemplary embodiments and not replaced with a different component in another exemplary embodiment, is therefore also described as an at least potentially existing component for this other exemplary embodiment. In the respective drawings:

FIG. 1 shows a perspective representation of a hydraulically actuatable handheld device in the form of a punch device;

FIG. 2 shows a bottom view of a pivoting jaw of the punch device, which features a punch opening;

FIG. 3 shows a schematic bottom view of a pivoting jaw with a punch opening according to a second embodiment;

FIG. 4 shows a partial longitudinal section through the pivoting jaws of the punch device during the course of a punching operation, namely regarding a punching position, in which the punch sleeve initially penetrates into the punch opening through the material to be punched with a front region;

FIG. 5 shows a follow-up illustration of FIG. 4 immediately after the punching operation has taken place;

FIG. 6 shows the enlarged region of the punch sleeve and the punch opening immediately before the penetration of the front punch sleeve region into the material to be punched;

FIG. 7 shows an enlarged representation of the situation according to FIG. 4;

FIG. 8 shows a follow-up illustration of FIG. 7 regarding the end position of the punch sleeve, which is defined by a stop;

FIG. 9 shows the section along the line IX-IX in FIG. 8;

FIG. 10 shows a sectional representation according to FIG. 8 regarding another embodiment of the punch device;

FIG. 11 shows a perspective detail of the punch sleeve;

FIG. 12 shows a bottom view of the punch edge of the punch sleeve;

FIG. 13 shows another perspective representation of the punch sleeve with surrounding stripper sleeve;

FIG. 14 shows a sectional representation of the arrangement according to FIG. 13;

FIG. 15 shows a top view of a punch edge with a square outline according to another embodiment;

FIG. 16 shows the section along the line XVI-XVI in FIG. 15;

FIG. 17 shows the section along the line XVII-XVII in FIG. 15;

FIG. 18 shows a sectional representation corresponding to FIG. 16 regarding another embodiment;

FIG. 19 shows an exploded perspective representation of an embodiment of the punch sleeve, the stripper sleeve and the punch ram;

FIG. 20 shows the section along the line XX-XX in FIG. 9 regarding the embodiment according to FIG. 19;

FIG. 21 shows a receptacle section of the punch ram in another embodiment, in which the locking pin associated with the punch sleeve is illustrated with dot-dash lines;

FIG. 21 shows the punch ram with a punch sleeve fixed thereon regarding another embodiment in a plane of section according to the illustration in FIG. 9;

FIG. 23 shows a sectional representation according to FIG. 22 regarding another embodiment;

FIG. 24 shows a sectional representation according to FIG. 20 regarding another embodiment;

FIG. 25 shows a sectional representation according to

FIG. 22 of another embodiment regarding a rotational/locking position of the punch sleeve on the punch ram;

FIG. 26 shows an illustration corresponding to FIG. 25 regarding the unlocking position;

FIG. 27 shows another embodiment in the form of a sectional representation according to FIG. 22;

FIG. 28 shows a perspective representation of the punch ram regarding the embodiment according to FIG. 27; and

FIG. 29 shows an illustration corresponding to FIG. 6 regarding another embodiment.

### DESCRIPTION OF THE EMBODIMENTS

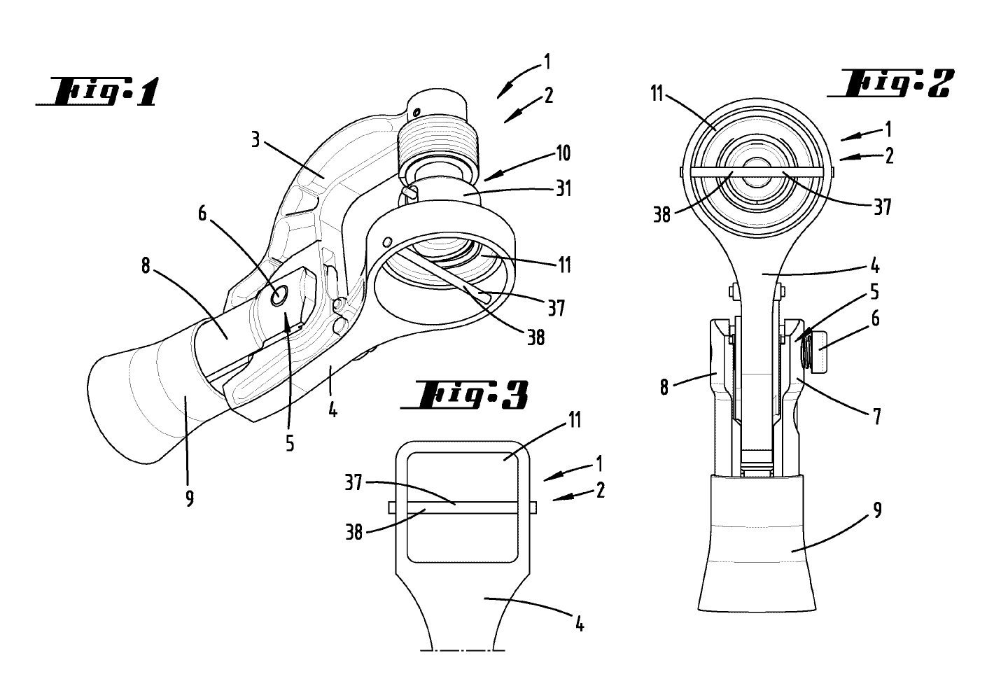

An electrohydraulically actuatable handheld device 1 in the form of a punch device 2 with a jaw pair, which is realized in the form of a sliding jaw pair in this case, is initially described below with reference to FIGS. 1-9.

FIG. 10 shows such a handheld device 1 or punch device 2 with a jaw pair in the form of a sliding jaw pair.

The punch device 2 is preferably operated by means of an attachable pressing device. This pressing device preferably consists of a pressing device of the type illustrated and described in WO 03/084719 A2 (U.S. Pat. No. 7,412,868 B2). With respect to the explanation of the preferred hydraulic device used, we hereby refer to the complete content of the aforementioned WO or US publication, namely also for the purpose of incorporating characteristics regarding the design of the device, which are respectively described in the WO or US publication, into claims of the present application.

The pivoting jaws 3 and 4 of the first embodiment illustrated in FIGS. 1-9 are connected to one another by means of a pivot joint 5. Starting with the pivot joint 5, the pivoting jaws 3 and 4 are on the side of the device basically realized in the same way as described in DE 10 2005 028 083 A1 (U.S. Pat. No. 7,216,532 B2). In this respect, the complete content disclosed in this publication is hereby likewise incorporated into the disclosure of the present application, namely also for the purpose of integrating characteristics of this already known publication in the present application.

In the assembled state, a mounting bolt 6 extends through the bearing openings for the pivoting jaws 3 and 4 formed in the pivot joint 5.

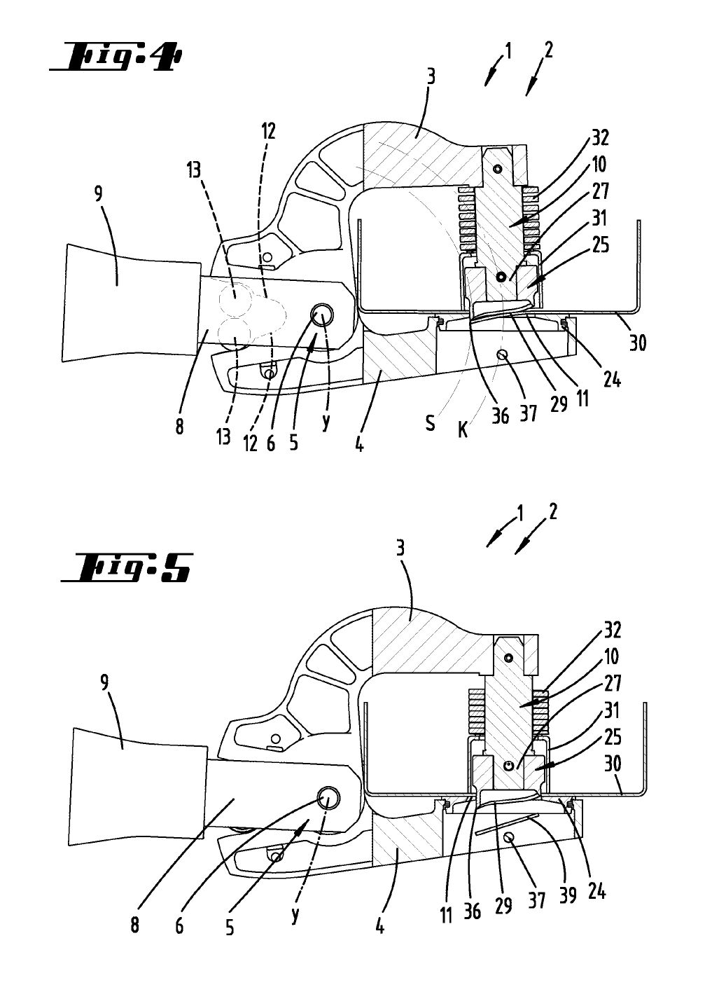

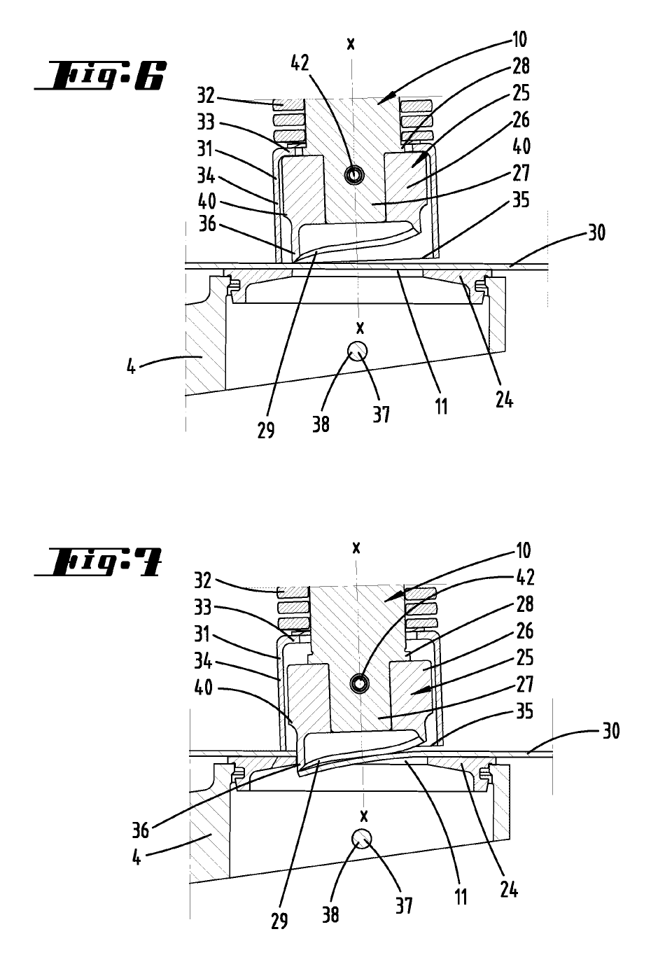

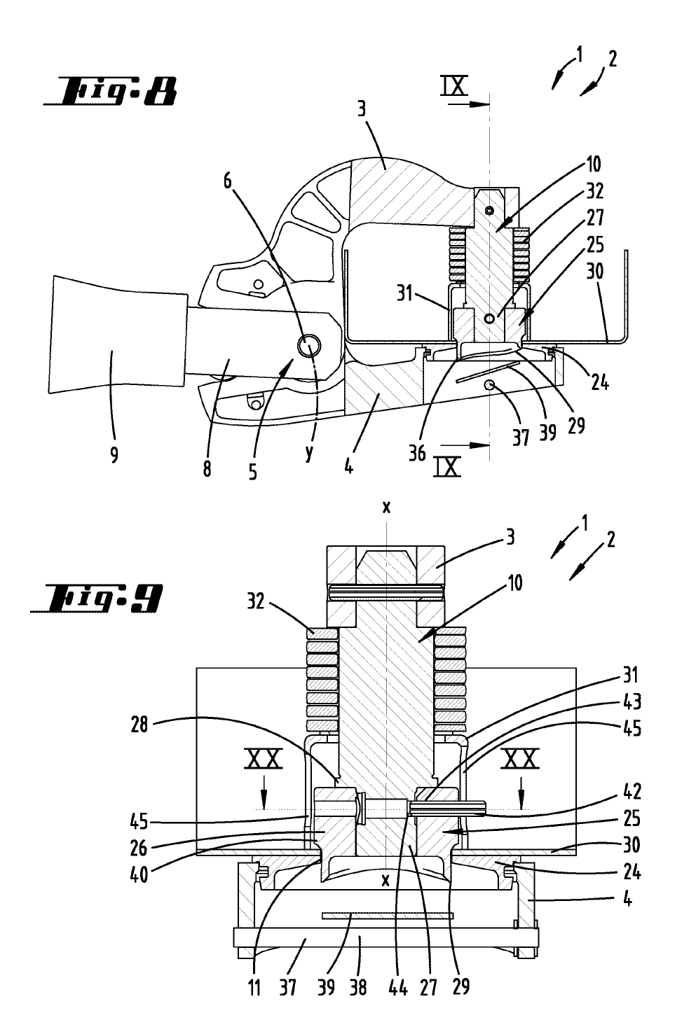

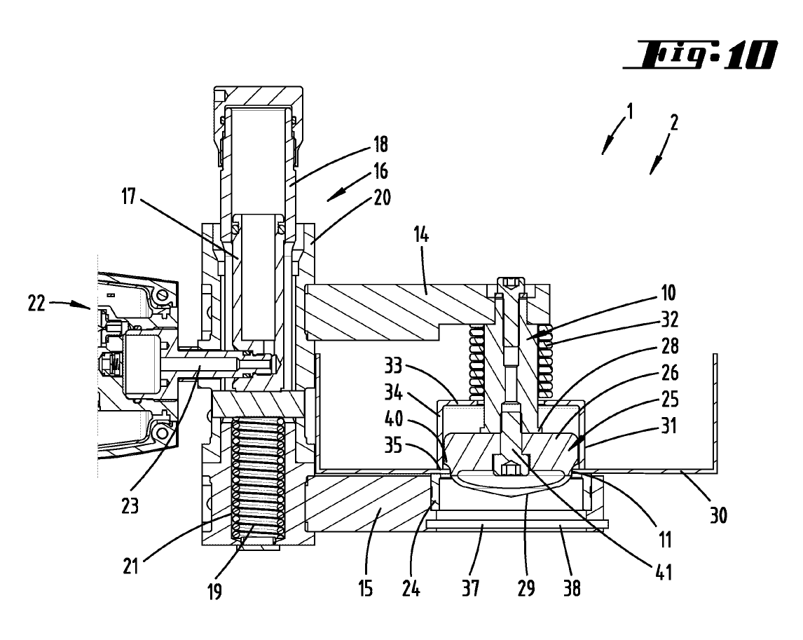

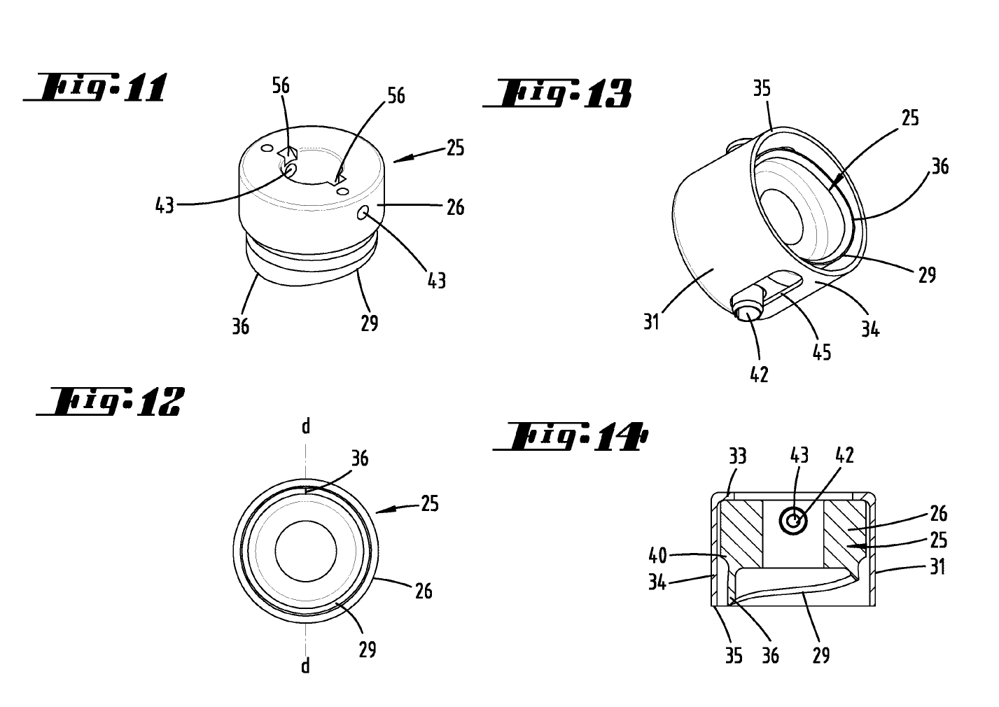

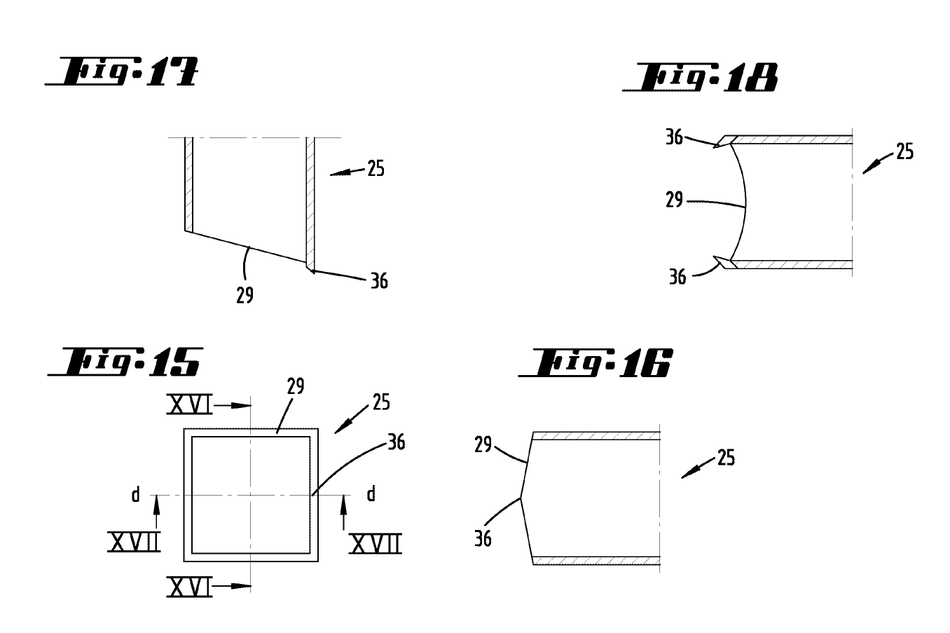

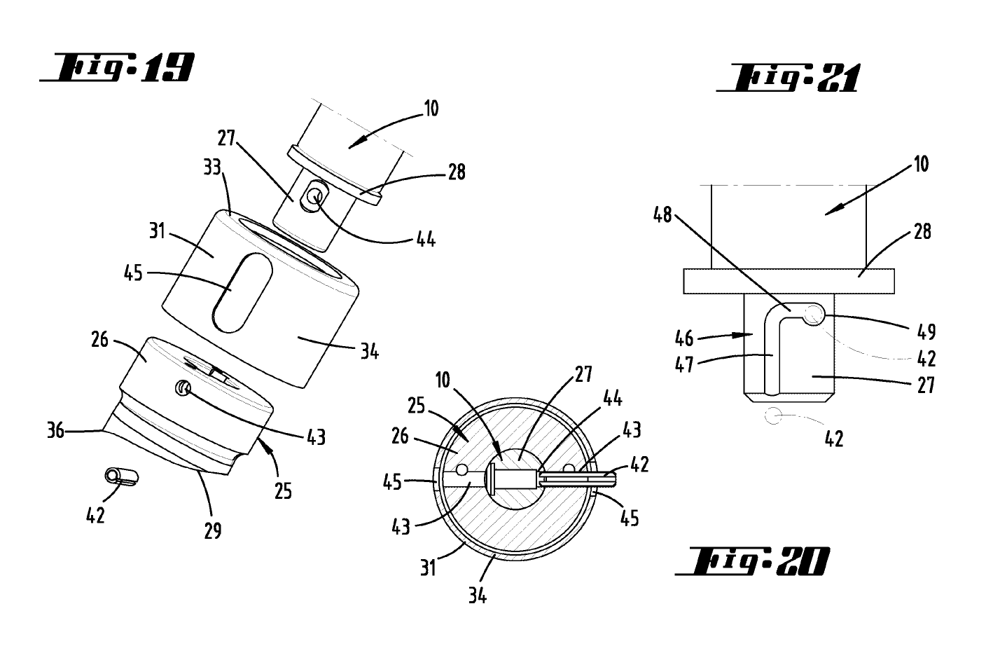

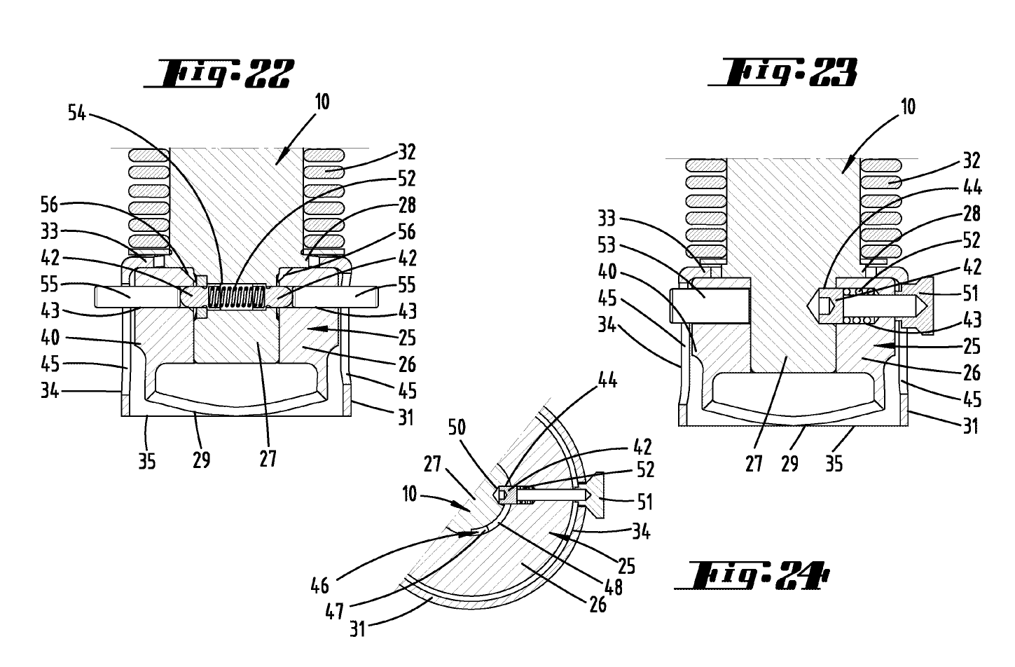

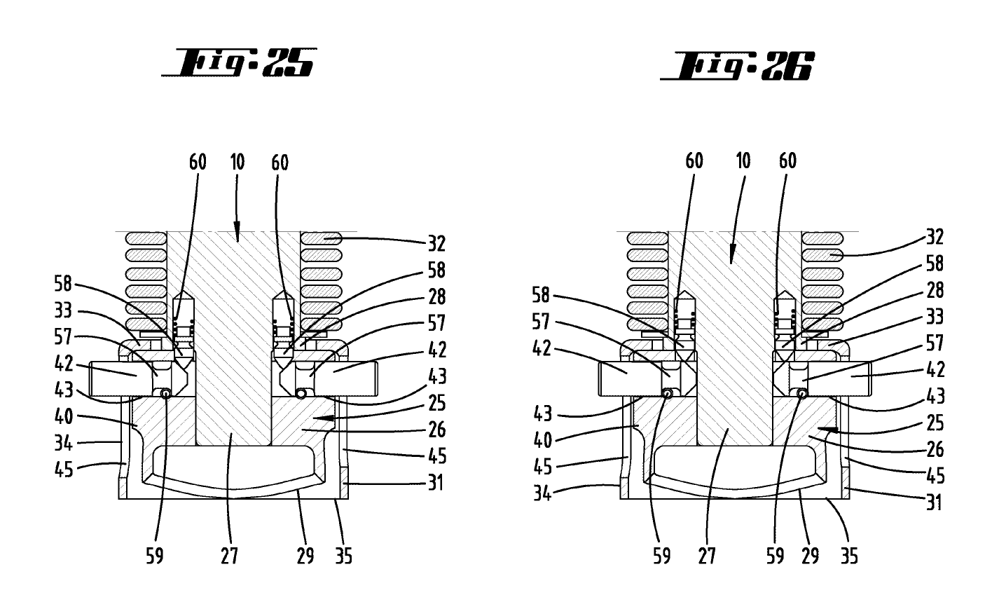

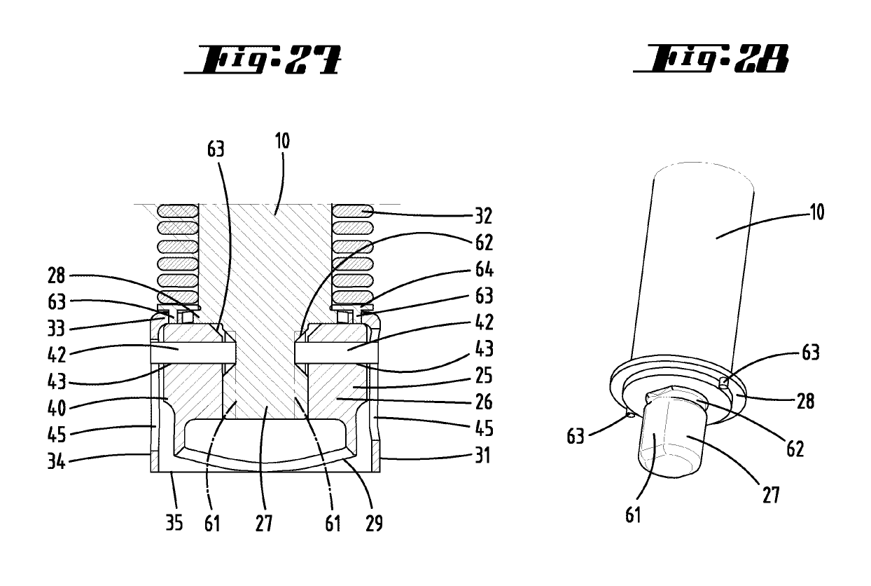

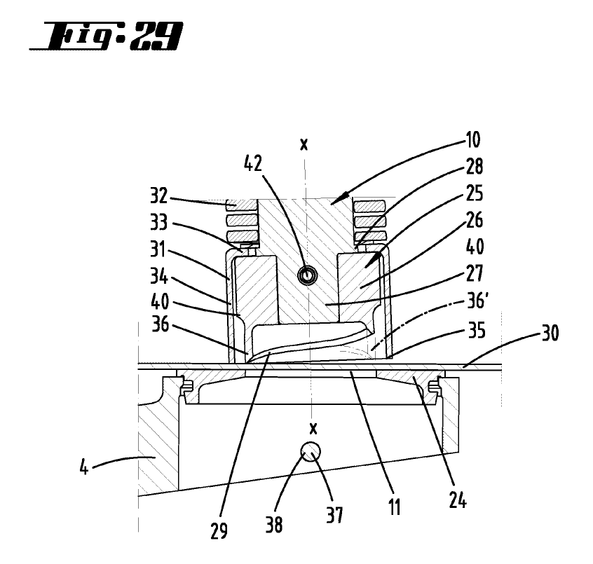

According to FIG. 2, for example, the mounting bolt 6 furthermore extends through two arms 7, 8 of a mounting neck 9. The hydraulic device, particularly an electrohydraulic device, is arranged on the mounting neck 9.

The mounting bolt 6 may particularly consist of a bolt of the type known from EP 1 491 295 (US 2005/0011236 A1). The complete relevant content of this publication is hereby likewise incorporated into the disclosure of the present application, namely also for the purpose of integrating characteristics of this publication in the claims of the present application.

Starting from the pivot joint 5, the pivoting jaws 3 and 4 are designed differently in the direction of their free ends. In a side view according to FIG. 4, the pivoting jaw 3 has an angular shape, wherein a first jaw section initially extends approximately vertical from the pivot joint 5 referred to a punching position according to FIG. 8 and a horizontal second jaw section extends adjacent thereto. A punch ram 10 is mounted in the region of the free end of the second jaw section, which is referred to as horizontally extending jaw section in this case.

With reference to a side view in the punching position according to FIG. 8, in particular, the other pivoting jaw 4 extends essentially horizontal starting from the pivot joint 5, preferably in approximately parallel orientation with the second jaw section of the pivoting jaw 3. On its end, the pivoting jaw 4 forms a punch opening 11 that can be overlapped with the punch ram 10.

In the region of their facing surfaces in the overlapping region, the pivoting jaws 3 and 4 form action surfaces 12 toward the arms 7 and 8 of the holding neck. These are acted upon by rollers 13 mounted in the mounting neck 9 on a not-shown linearly displaceable piston. The rollers 13, which are linearly displaced simultaneously during the operation of the device, act upon the action surfaces 13 in such a way that the pivoting jaws 3 and 4 carry out a pivoting motion and the punch ram 10 is moved in the direction of the punch opening 11 of the other pivoting jaw.

The pivoting jaws 3 and 4 may be preloaded into a home position, particularly into an open position of the pivoting jaws, by means of a spring such as a tension spring that is arranged, for example, near the pivot joint in the overlapping region with the arms 7 and 8.

The design with sliding jaws 14, 15 according to FIG. 10 is illustrated and described, particularly with respect to its structure and its function, in WO 2013/017535 (US 2014/0251104 A1). In this respect, the complete content disclosed in this publication is hereby likewise incorporated into the disclosure of the present application, namely also for the purpose of integrating characteristics of this already known publication into the present application.

The sliding jaws 14 and 15 essentially extend parallel to one another and are mounted on a displacement device 16 with their ends, which lie opposite of their ends that respectively carry the punch ram 10 and form the punch opening 11. This displacement device 16 particularly consists of a piston part 17 and a cylinder part 18. It furthermore comprises a return spring 19.

The piston part 17 and the cylinder part 18 are accommodated concentric to one another in a housing 20. A receptacle 21, in which the return spring 19 is accommodated, is formed in an extension of the cylinder part 18. The cylinder part 18 and the receptacle 21 are realized in one piece in order to carry out a common motion.

The sliding jaw 14 featuring the punch ram 10 is rigidly connected to the housing 20 and the sliding jaw 15 featuring the punch opening 11 respectively is rigidly connected to the cylinder part 18 or the receptacle 21.

During an actuation, the piston part 17 remains stationary relative to the electrohydraulic device 22 analogous to the housing 20 whereas the cylinder part 18 moves together with the receptacle 21. For this purpose, hydraulic fluid is pumped from the device 22 into the piston part 17 through a connecting line 23.

The cylinder part 18 is linearly displaced as a result of the pressurization with hydraulic fluid. Since the receptacle 21 is thereby simultaneously moved, the return spring 19 is correspondingly compressed and tensioned.

The linear displacement of the cylinder part 18 causes a corresponding displacement of the sliding jaw 15 in the direction of the punch ram 10 while the parallel orientation relative to the sliding jaw 14 is preserved.

Regardless of whether the punch device 2 is realized with pivoting jaws 3, 4 or sliding jaws 14, 15, the punch opening 11 may be realized in the form of a punch insert 24 that may consist, for example, of a suitably hardened annular metal part.

The punch ram may have a round outline as illustrated in FIGS. 1, 2 and 4-14 such that the punch opening 11 is accordingly also realized with a round outline.

In an exemplary embodiment of the punch ram 10 with a noncircular outline, for example a square outline (according to the illustrations in FIGS. 15-18), the outline of the punch opening 11 is realized in a correspondingly adapted fashion, for example square (see FIG. 3).

The punch ram 10 is mounted in the region of the free end of the pivoting jaw 3 or the sliding jaw 14 in such a way that the punch ram axis x extends essentially perpendicular to the orientation of the section of the pivoting jaw 3 or the sliding jaw 14, on which the punch ram 10 is mounted.

The free end of the punch ram 10 points in the direction of the punch opening 11. A punch sleeve 25 is fixed on the punch ram 10 in the region of its free end.

The punch sleeve 25 is mounted on the punch ram 10 in an exchangeable fashion as described in greater detail further below, wherein the punch insert 24 in the region of the punch opening 11 may, if applicable, also be mounted in an exchangeable fashion in order to realize a corresponding adaptation to the punch sleeve 25 arranged on the punch ram 10.

The punch sleeve 25 features a mounting section 26 that altogether has an essentially annular shape. An arbor 27, which in other respects has a reduced diameter referred to the punch ram 10, extends through this mounting section when it is arranged in its position on the punch ram 10. The free end face of the arbor 27 can preferably end with an end face of the mounting section 26.

On the opposite side of this end face, the punch ram 10 can act upon the upper side of the punch sleeve 25 by means of a collar 28, which in other respects is radially widened referred to the punch ram 10.

A punch edge 29 is formed on the punch sleeve 25 such that it protrudes over the end face. This punch edge is realized circumferentially referred to the punch ram axis x that also extends centrally through the punch sleeve 25. The outline geometry of the punch edge 29 is decisive for the punch pattern. For example, the punch edge 29 is realized with an annular outline (see FIG. 12) in order to punch out circular openings.

In order to punch out, for example, square openings from a material 30 to be punched, the punch edge 29 is accordingly realized with a square outline (see FIGS. 15-18).

The punch opening 11 or the punch insert 12 is respectively adapted to the geometric outline of the punch edge 29.

The punch sleeve 25 is surrounded by a stripper sleeve 31 that can preferably be moved relative to the punch sleeve 25 against the force of a pressure spring 32.

The stripper sleeve 31 altogether has a pot-like design with a bottom section 33, which is oriented transverse to the punch ram axis x and features a central opening for the passage of the punch ram 10.

The pressure spring 32 encompassing the punch ram 10 is supported on the associated pivoting jaw 3 or sliding jaw 14 with one end and acts upon the bottom section 33 of the stripper sleeve 31 with its other end either directly or preferably by means of an intermediately arranged annular base plate 64 (see FIG. 27) such that the stripper sleeve 31 is preloaded in the direction of a contact position with the punch insert 24.

In a home position of the punch device 2, the bottom section 33 of the stripper sleeve 31 is supported on the mounting section 26 of the punch sleeve 25, the diameter of which is enlarged referred to the collar 28 of the punch ram 10. In this position, a circumferential wall 34 originating from the bottom section 33 encompasses the punch sleeve 25 in such a way that a front outer edge 35 of the wall 34 is aligned with or protrudes over one or more front regions 36 of the punch edge 29.

The stripper sleeve 31 can be moved relative to the punch sleeve 25 along the punch ram axis x.

The stripper sleeve 31 engages behind the punch sleeve 25 with the bottom section 33. The stripper sleeve is insofar positively mounted and thereby secured against being pulled off forward over the punch sleeve 25.

The punch edge 29 is provided with a front region 36 referred to the direction of the punch ram axis x, particularly if the punch edge has a circular outline.

During the course of a punching operation, this front region moves along a pivoting circle S, the center point of which is formed by the pivoting axis y of the pivoting jaws 3, 4 in the region of the pivot joint 5.

With reference to a side view according to FIG. 4, in which the pivoting axis y is punctiform, the pivoting circle S is formed on the side of the circular line K facing the pivoting axis y, wherein the punch sleeve 25 and the punch ram 10 jointly move along said circular line K during a punching operation. The center point of the circular line K also lies in the pivoting axis y and the circular line is tangent to the punch ram axis x.

The front region 36 is accordingly arranged and formed on the punch edge 29 in such a way that it definitely impinges first upon the material 30 to be punched lying on the punch insert 24 (see FIG. 6) during the course of the pivoting motion of the pivoting jaws 3 and 4. Accordingly, the front region 36 penetrates into the material 30 to be punched before the punch edge 29 during the course of the further pivoting motion. This simultaneously leads to a centering of the punch ram 10 with its punch sleeve 25 relative to the punch opening 11.

A frictional connection between the collar 28 of the punch ram 10 and the punch sleeve 25 is achieved during the course of the punching operation.

In addition, the stripper sleeve 31 is during the course of the punching operation supported on the surface of the material 30 to be punched with its outer edge that surrounds the punching region.

In a potential design of the punch edge 29 with a square outline, the front region 36 may be formed in the center of a wall section of the punch edge 29 (see FIGS. 15-17). Alternatively, a front region 36 may also be respectively arranged to both sides of a diametric line d, which during the use of the punch device extends perpendicular to the pivoting axis y, in the region of the edge section lying closest to the pivoting axis y as illustrated in the sectional representation according to FIG. 18, wherein the plane of section in FIG. 18 corresponds to the plane of section in FIG. 16. It is preferred to realize a symmetric arrangement of the front regions 36 referred to the diametric line d. For example, these front regions 36 may be formed in the region of the corners of the wall section of the punch edge 29, which lies closest to the pivoting axis y.

In this case, an initial centering also takes place during the course of the punching operation as a result of the initial penetration of the front regions 36 into the material 30 to be punched and into the punch opening 11.

A holding element 37 may be provided in the pivoting jaw 4 or in the sliding jaw 15 underneath the punch opening 11 referred to the punching direction and at a distance from the opening plane. This holding element may consist of a holding rod 38 that traverses the punch opening 11 in a projection of the punch opening 11 in the punching direction.

The holding rod 38 is preferably arranged in such a way that it divides the area of the punch opening 11 into identical sections in the projection. If the punch opening area is circular, for example, the holding rod 38 is preferably arranged along a diametric line (see FIG. 2).

In a potential rectangular design of the punch opening 11 according to the illustration in FIG. 3, the holding rod 38 or the holding element 37 preferably extends perpendicular to an outer edge of the punch opening 11, particularly in the center of the outer edges that essentially extend parallel to the holding rod 38.

It is furthermore preferred that the holding rod 38 extends through the center point of the area encompassed by the outer edge of the punch opening 11 regardless of the outline of the punch opening 11.

The holding element 37 collects sections 39 that are cut out of the material 30 to be punched.

The punch sleeve 35 is furthermore provided with a stop 40. This stop is set back from the connection of the punch edge 39 to the mounting section 36 in the displacement or punching direction and essentially realized in the form of an outwardly directed radial step.

The stop 40 may be realized in the form of a circumferential shoulder referred to the punch ram axis x, wherein the stop 40 may in a cross-sectional contour, for example according to the illustration in FIG. 14, furthermore extend in a curved fashion in the stopping direction.

After the punching operation has been carried out, the punch sleeve 35 is ultimately supported on the circumferential outer edge of the opening punched out of the material 30 to be punched by means of the stop 40.

According to the illustration in FIG. 10, the punch sleeve 25 may be mounted on the punch ram 10 in an exchangeable fashion, for example, by means of a screw 41 that extends through the mounting section 26 along the punch ram axis x and engages into a threaded bore of the punch ram 10.

The clamping sleeve 25 can furthermore be fixed on the punch ram 10 by means of a locking pin 42 that is oriented radially to the punch ram axis x. According to the first embodiment, the locking pin 42 may consist of a clamping sleeve as illustrated, in particular, in FIGS. 13, 14 and 19, 20, wherein said clamping sleeve extends through a radial bore 43 in the mounting section 26 in order to engage into a likewise radially oriented interlock opening 44 formed in the arbor 27 of the punch ram 10.

The mounting position is non-positively secured due to the design of the locking pin 42 in the form of a clamping sleeve.

The locking pin 42 may also serve for guiding the stripper sleeve 31. For this purpose, the locking pin 42 also protrudes radially over the wall of the mounting section 26 in the locking position and extends through an oblong hole 45 in the stripper sleeve wall 34, which is oriented in the direction of the punch ram axis x.

The length of the locking pin 42 is preferably chosen in such a way that this locking pin can also be taken hold of by the user from outside the stripper sleeve 31 in the locking position.

The length of the oblong hole 45 is adapted to the potential displacement travel of the stripper sleeve 31 relative to the punch sleeve 25.

With reference to a cross section according to FIG. 20, it is also possible to provide two diametrically opposite locking pins 42 that are correspondingly seated in radial bores 43 of the mounting section 26 and engage into the preferably continuous interlock opening 44 of the punch ram 10. In this case, it is also preferred to provide two oblong holes 45 in the wall 34 of the stripper sleeve 31, into which the free end regions of the locking pins 42 engage in a guiding fashion.

Other embodiments regarding the locking of the punch sleeve 25 on the punch ram 10 are described below, wherein these embodiments make it possible to respectively mount and dismount the punch sleeve without tools and preferably with only one hand.

The one locking pin 42 may be realized in the form of a clamping sleeve, which is held in the region of the mounting section 26 and protrudes radially inward into the resulting central clearance of the mounting section 26, wherein said clamping sleeve can be used in conjunction with a slotted link guide 46 on the punch ram 10.

Such a slotted link guide 46 is illustrated, for example, in FIG. 21. This slotted link guide is formed in the region of the arbor 27 on the side of the ram and realized in the form of a groove in the outer side of the wall.

The slotted link features a removal section 47 that extends in the direction of the punch ram axis x and ends openly in the region of the free end face of the arbor 27. The removal section 47 transforms into a locking section 48 that is axially spaced apart from the end face and extends transverse to the punch ram axis x. This locking section extends over part of the arbor circumference.

The width transverse to the longitudinal direction of the groove-like sections may be chosen in such a way that the clamping sleeve cooperating therewith can only be displaced along the locking section 48 in the tensioned state of the locking section 48, in which its diameter is correspondingly reduced, by rotating the punch sleeve 25 about the punch ram axis x while the punch sleeve 25 is attached along the axis x.

A catch-secured mounting position of the punch sleeve 25 on the punch ram 10 can be achieved with a corresponding design of a catch section 49 that is formed on the end of the locking section 48 and at least has a diameter that corresponds to the diameter of the clamping sleeve in the relaxed state. Accordingly, the clamping sleeve can relax upon reaching the catch section 49 such that a backward displacement into the locking section 48 and onward into the removal section 47 can only be achieved by deliberately exerting a rotational force upon the punch sleeve 25 and thereby compressing the springable clamping sleeve.

Such a slotted link guide 46 may also be provided with a radially oriented catch depression 50 on the end of the locking section 48 (see sectional representation according to FIG. 24). Such a design is advantageous in conjunction with a radially displaceable locking pin 42 that is held in the mounting section 26 and spring-loaded radially inward.

A locking pin of this type, which is also illustrated in FIG. 23, may furthermore extend through an associated oblong hole 45 of the stripper sleeve 31 with its end that points radially outward and preferably feature a handle part 51, which can be taken hold of outside the stripper sleeve 31.

The locking pin 42 is captively held on the punch sleeve 25 and/or on the stripper sleeve 31.

In a potential embodiment, the locking pin 42, which is spring-loaded radially inward by means of a pressure spring 52, engages into an interlock opening 44 in the region of the arbor 27, for example an interlock opening 44 of the type illustrated in FIG. 19.

The punch sleeve 25 may also feature a mounting pin 43 in addition to the locking pin 42. This mounting pin is preferably held in the mounting section 26 circumferentially offset referred to the locking pin 42, particularly diametrically opposite of the locking pin 42.

The mounting pin 43 protrudes radially outward beyond the wall of the mounting section 26 in order to engage into the additional oblong hole 45 of the stripper sleeve 31.

The punch sleeve 25 and the stripper sleeve 31 can be jointly and easily separated from the punch ram 10 by displacing (pulling) the locking pin radially outward against the force of the pressure spring 52. Subsequently, the punch sleeve 25 can be freely removed in the direction of the punch ram axis x.

The punch sleeve 25 is removed from the punch ram 10 together with the stripper sleeve 31.

A pressure spring 52 acting transverse to the longitudinal axis x may also be arranged in a through-bore 54 in the region of the arbor 27, which is oriented transverse to the punch ram axis x, wherein the ends of said pressure spring respectively act upon locking pins 42. Accordingly, the latter are spring-loaded radially outward, wherein the locking pins 42 are captively held in the arbor 27.

In the locking position illustrated in FIG. 22, the locking pins 42 are displaced into a position, in which they overlap the parting plane between the punch ram 11 and the punch sleeve 25 such that the locking pins 42 longitudinally engage—referred to the bore axis—partially into the through-bore 54 of the ram and partially into associated radial bores 43 of the punch ram 11. In this way, the punch sleeve 25 is interlocked on the punch ram 11.

The interlock can be released by actuating and thereby displacing radially inward two spacers 55, which are respectively seated in the radial bores 43 of the punch sleeve 25 and realized in a rod-like fashion, wherein said spacers extend through the oblong holes 55 and are exposed radially outward in order to be actuated. The spacers 55 make it possible to press the locking pins 42 radially inward against the spring force acting thereupon, namely into a position, in which the parting planes between the spacers 55 and the locking pins 42 are aligned with the parting planes between the punch ram 10 and the punch sleeve 25. The punch sleeve 25 can be removed in this position.

After the removal of the punch sleeve 25, the locking pins 42 are displaced back into their home position, in which they partially protrude over the circumferential wall of the arbor 27, under the influence of the spring acting upon the locking pins. The spacers 55 captively remain on the punch sleeve 25.

The attachment of the punch sleeve 25 and the arbor 27 can be simplified in that diametrically opposite control bevels 56 are formed in the region of the circumferential outer edge of the opening in the mounting section 26, through which opening the arbor 27 penetrates (see FIG. 11). These control bevels displace the locking pins 42 radially inward during the course of an attachment of the punch sleeve 25 on the arbor 27. Once the end position is reached, the locking pins 42 automatically engage into the radial bores 43 of the punch sleeve in a spring-loaded fashion.

According to the illustrations in FIGS. 25 and 26, a locking pin 42 with a radially reduced waist section 57 may be provided for rotationally interlocking the punch sleeve 25 and the arbor 27, for example in the form of a bayonet-like connection. The locking pin 42 cooperates with an interlock pin 58.

In this embodiment, the locking pin 42 is preferably also held in the mounting section 26 of the punch sleeve 25 such that it can be moved transverse to the punch ram axis x. The captivity of the locking pin 42 is achieved by means of a securing pin 59 that engages into the waist section 57 and allows limited linear mobility of the locking pin 42 in the radial direction.

The end of the locking pin 42 facing the arbor 27 is realized conically. The ends of the interlock pins 58, which adjoin the conical surfaces of the locking pin ends, are also conically recessed.

The interlock pin 58 is held in the punch ram 10 such that it can be displaced in the direction of the punch ram axis x and spring-loaded in the direction of the locking pin 42 by means of a pressure spring 60.

The interlock pin 58 extends through a correspondingly positioned and oriented bore in the mounting section 26 and is supported on the conical surface of the locking pin 42 in the locking position. In the interlocking position according to FIG. 25, the interlock pin 58 extends through the bore with an essentially circular-cylindrical section such that the punch sleeve 25 is held on the punch ram 10 in a rotationally secured fashion.

According to the illustration in FIG. 25, it is preferred to provide two diametrically opposite locking pins 42 that accordingly cooperate with two interlock pins 58.

In order to release the rotationally locked position, the locking pins 42 are displaced radially inward as a result of the user exerting corresponding pressure thereupon. In this case, the interlock pins 58 are axially displaced back into the position according to FIG. 26 against the force of the pressure spring 60 due to the cooperation between the conical surfaces of the interlock pins 58 and the locking pins 42, wherein the conical surfaces of the interlock pins 58 are in this position aligned for cooperating with the bore wall of the mounting section 26.

The interlock pins 58 are additionally pushed out of the bores by rotating the stripper sleeve 31, which is preferably connected to the punch sleeve 25 in a rotationally rigid fashion, about the axis x.

The above-described embodiments for locking the punch sleeve 25 on the punch ram 10 make it possible to fix the punch sleeve 25 in the axial direction, as well as in the circumferential direction.

According to the embodiment in FIGS. 27 and 28, a non-displaceable locking pin 42 may also be arranged in the mounting section 26 such that it is oriented transverse to the punch ram axis x, wherein this locking pin engages into an associated oblong hole 45 of the stripper sleeve 31 with one end and freely protrudes radially inward into the central opening of the mounting section 26.

In a conventional circular outline, the arbor 27 of the punch ram 10 is in two opposite regions provided with flattening 61, which respectively form surfaces that are oriented parallel to one another and nearly extend over the entire free length of the arbor 27.

Two oppositely arranged locking pins 42 may also be provided as shown.

The distance between the flattening surfaces of the arbor 27 referred to the outline is chosen equal to or smaller than the distance between the facing end faces of the locking pins 42. In this way, the punch sleeve 25 can be attached to the arbor 27 from the free end thereof, wherein the end faces of the locking pins 42 are guided by the flattening surfaces.

A bayonet-like lock is achieved in that the ends of the locking pins 42, which freely protrude inward, enter the region of a circumferential locking groove 62 formed on the arbor 27 after the punch sleeve 25 has been completely attached to the arbor 27, wherein the locking pins 42 engage into said locking groove 62 in a locking fashion after rotating the punch sleeve 25 about the punch ram axis x.

The punch sleeve 25 can be rotationally secured relative to the punch ram 10 due to the engagement of pins 63 of the punch ram into correspondingly positioned bores in the region of the bottom section 33 of the stripper sleeve.

The pins 63 may be integrally formed on a base plate 64 that supports the pressure spring 32.

In addition to the front region 36, the punch sleeve 25 may feature another front region 36′ in the outer region referred to the pivoting axis y as illustrated in an exemplary fashion with dot-dash lines in FIG. 29. If the punch edge 29 is designed with a circular outline, for example, this additional front region preferably lies diametrically opposite of the front region 36.

The additional front region 36′ may lead or trail the front region 36 during the course of a punching operation.

A trailing arrangement may be advantageous with respect to a potentially oriented mounting in the direction of the pivoting axis.

A leading arrangement may be advantageous if (radially) outward yielding should be counteracted, for example as a result of material properties.

The preceding explanations serve for elucidating all inventions that are included in this application and respectively enhance the prior art independently with at least the following combinations of characteristics, namely:

A punch jaw, which is characterized in that the punch sleeve 25 being introduced into the punch opening 11 in a side view initially penetrates the punch opening 11 with a front region 36 of its punch edge 29 referred to the pivoting direction, and in that the front region 36 is in this side view formed on the side of the pivoting axis y of the circular line K with respect to a pivoting circle S, along which the punch sleeve 25 moves.

A punch device, which is characterized in that a holding element 37 extends through the punch opening 11 with an offset relative to an outer edge of the punch opening 11 in the punching direction.

A punch device, which is characterized in that the punch edge 29 features a stop 40 that in a cross section is set back in the displacement direction and arranged outward referred to the punch edge 29, wherein said stop can come in contact with the material 30 to be punched during the course of a punching operation.

A punch device, which is characterized in that a locking element can be displaced into a release position against a spring force and/or moved into a release position by means of a slotted link guide 46.

A punch jaw or a punch device, which are characterized in that the front region 36 is in a top view of the punch sleeve 25, in which the pivoting axis y represents a line, realized symmetrically referred to a diametric line d of the punch sleeve 25 extending perpendicular to the pivoting axis y.

A punch jaw or a punch device, which are characterized in that the front region 36 includes the section of the punch edge 29, which in the aforementioned side view extends closest to the pivoting axis y.

A punch jaw or a punch device, which are characterized in that the cant of the front region 36 in the pivoting direction is formed in the section of the punch edge 29 located closest to the pivoting axis y.

A punch jaw or a punch device, which are characterized in that the holding element 37 is a holding rod 38.

A punch jaw or a punch device, which are characterized in that the holding rod 38 extends on a diametric line if the outer edge 35 is realized annular.

A punch jaw or a punch device, which are characterized in that the holding rod 38 extends perpendicular to at least one side of the outer edge 35 and/or through a center point of the area encompassed by the outer edge 35 if the outer edge 35 is realized rectangular or square.

A punch jaw or a punch device, which are characterized in that the stop 40 is realized in the form of a circumferential shoulder.

A punch jaw or a punch device, which are characterized in that the stop 40 extends in a cross-sectional contour in a curved fashion in the stopping direction.

A punch jaw or a punch device, which are characterized in that the locking element is a locking pin 42 that is spring-loaded radially inward and arranged in the punch sleeve 25 in a radially movable fashion.

A punch jaw or a punch device, which are characterized in that the locking pin 42 penetrates into an interlock opening 44 of the punch ram 10 in a locking position.

A punch jaw or a punch device, which are characterized in that the punch sleeve 25 is surrounded by a stripper sleeve 31, and in that the locking pin 42 extends through the stripper sleeve 31.

A punch jaw or a punch device, which are characterized in that the locking pin 42 can be actuated from outside the stripper sleeve 31.

A punch jaw or a punch device, which are characterized in that a mounting pin 53 is arranged on the punch sleeve 25 in addition to the locking pin 42 and extends through the stripper sleeve 31 with a circumferential offset referred to the locking pin 42.

A punch jaw or a punch device, which are characterized in that the locking pin 42 and/or the mounting pin 53 are accommodated in an oblong hole 45 of the stripper sleeve 31.

A punch jaw or a punch device, which are characterized in that the locking pin 42 can be spring-loaded into the locking position by means of a spring element arranged in the punch ram 10.

A punch jaw or a punch device, which are characterized in that the locking pin 42 is captively held on the stripper sleeve 31.

A punch jaw or a punch device, which are characterized in that the spring 52 is arranged in the punch ram 10 in such a way that it acts in the displacement direction of the locking pin 42.

A punch jaw or a punch device, which are characterized in that a locking pin 42 supported on the spring 52 acts upon a spacer 55 that can be displaced into a parting plane between the punch ram 10 and the punch sleeve 25 with respect to its end associated with the locking pin 42.

A punch jaw or a punch device, which are characterized in that two cross-sectionally opposite locking pins 42 are provided.

A punch jaw or a punch device, which are characterized in that two cross-sectionally opposite spacers 55 are provided.

A punch jaw or a punch device, which are characterized in that the opposite locking pins 42 are acted upon by the same spring 52.

A punch jaw or a punch device, which are characterized in that the locking pin 42 can on the side of the punch ram be moved in an angular slotted link formed on the punch ram 10.

A punch jaw or a punch device, which are characterized in that the slotted link features a locking section 48 extending transverse to the longitudinal axis of the punch ram 10 and a removal section 47 extending in the direction of the longitudinal axis.

A punch jaw or a punch device, which are characterized in that a locking recess 50 is formed on end of the locking section 48 that lies opposite of the removal section 47.

A punch jaw or a punch device, which are characterized in that the locking pin 42 can only exit the locking recess 50 against a spring force.

All disclosed characteristics are essential to the invention (individually, but also in combination with one another). The disclosure content of the associated/attached priority documents (copy of the priority application) is hereby fully incorporated into the disclosure of this application, namely also for the purpose of integrating characteristics of these documents into claims of the present application. The characteristic features of the dependent claims characterize independent inventive enhancements of the prior art, particularly for submitting divisional applications on the basis of these claims.

### LIST OF REFERENCE SYMBOLS

1 Handheld device
2 Punch device

### 3 Pivoting jaw

### 4 Pivoting jaw

5 Pivot joint
6 Mounting bolt

### 7 Arm

### 8 Arm

9 Mounting neck

### 10 Punch ram

11 Punch opening
12 Action surface

### 13 Roller

### 14 Sliding jaw

### 15 Sliding jaw

16 Displacement direction
17 Piston part
18 Cylinder part
19 Return spring

### 20 Housing

### 21 Receptacle

### 22 Device

23 Connecting line
24 Punch insert
25 Punch sleeve
26 Mounting section

### 27 Arbor

### 28 Collar

29 Punch edge
30 Material to be punched
31 Stripper sleeve
32 Pressure spring
33 Bottom section

### 34 Wall

35 Outer edge
36 Front region
36′ Front region
47 Holding element

### 38 Holding rod

### 39 Section

### 40 Stop

### 41 Screw

### 42 Locking pin

43 Radial bore
44 Interlock opening
45 Oblong hole
46 Slotted link guide
47 Removal section
48 Locking section
49 Catch section
50 Catch depression/locking recess
51 Handle part
52 Pressure spring

### 53 Mounting pin

### 54 Through-bore

### 55 Spacer

56 Control bevel
47 Waist section

### 58 Interlock pin

### 59 Securing pin

60 Pressure spring

### 61 Flattening

62 Locking groove

### 63 Pin

64 Base plate
d Diametric line
x Punch ram axis
y Pivoting axis
K Circular line
S Pivoting circle

1. Punch jaws configured to punch holes and/or recesses in parts made of sheet metal comprising:
first and second jaws pivotally connected to each other around a pivoting axis to pivot in a pivoting plane,
wherein a work region is formed by a punch ram on the first pivoting jaw and a punch opening on the second pivoting jaw, wherein the punch ram carries a punch sleeve, the punch sleeve having a punch edge on its circumference, and wherein the punch sleeve moves in a side view, in which the pivoting axis is punctiform, along a circular line, a center point of which is formed by the pivoting axis, during its pivoting motion,
the punch sleeve is introduced into the punch opening in a side view initially penetrates the punch opening with a front region the punch edge referred to the pivoting direction, and in that the front region is in this side view formed on the side of the pivoting axis of the circular line with respect to a pivoting circle, along which the punch sleeve moves.

2-30. (canceled)
